(19) United States
(12) Patent Application Publication
(10) Pub. No.: US 2024/0228328 A9
(43) Pub. Date: Jul. 11, 2024

(54) METHOD AND SYSTEM FOR RECYCLING HEAVY OIL PRODUCED WATER FOR USE IN STEAM INJECTION BOILER WITHOUT DESILICATION

(71) Applicants: CHINA NATIONAL PETROLEUM CORPORATION, Beijing (CN); CNPC RESEARCH INSTITUTE OF SAFETY & ENVIRONMENT TECHNOLOGY CO., LTD., Beijing (CN)

(72) Inventors: Jiacai XIE, Beijing (CN); Kun TONG, Beijing (CN); Zixian WANG, Beijing (CN); Zhiguo SHAO, Beijing (CN); Fan NIE, Beijing (CN)

(21) Appl. No.: 18/535,904

(22) Filed: Dec. 11, 2023

Related U.S. Application Data
(63) Continuation-in-part of application No. PCT/CN2022/096753, filed on Jun. 2, 2022.

(30) Foreign Application Priority Data
Jun. 9, 2021 (CN) 202110642524.0
Jun. 9, 2021 (CN) 202110642537.8

(51) Int. Cl. C02F 1/28; C02F 1/00; C02F 1/24; C02F 103/36

(52) U.S. Cl. CPC C02F 1/285; C02F 1/001; C02F 1/24; C02F 2103/365; C02F 2209/02; C02F 2209/055; C02F 2209/44

(57) ABSTRACT

The present invention discloses a method for recycling heavy oil produced water for use in a steam injection boiler without desilication, comprising: the heavy oil produced water sequentially undergoes pre-treatment, filtration treatment and divalent and trivalent scaling ion removal by using a macroporous weak acid resin and the like. The method may reduce the concentration of the divalent and trivalent scaling ions in the heavy oil produced water to below 50 μg/L, and can recycle high-silicon-containing heavy oil produced water for use in the steam injection boiler without desilication. Further disclosed is a system for recycling heavy oil produced water for use in a steam injection boiler without desilication.

### CROSS-REFERENCE TO RELATED APPLICATIONS

This application is a continuation-in-part of International Application No. PCT/CN2022/096753, filed on Jun. 2, 2022, which claims priority to Chinese Patent Application No. 202110642537.8 and No. 202110642524.0, both filed on Jun. 9, 2021, all of which are hereby incorporated by reference in their entirety.

### TECHNICAL FIELD

The present disclosure relates to the technical field for recycling heavy oil produced water for use in a steam injection boiler, and in particular relates to a method and system for recycling heavy oil produced water for use in a steam injection boiler without desilication.

### BACKGROUND

Heavy oil resources are widely distributed and rich in reserves, accounting for more than 25-30% of total oil resources, and have become one of the important energy reservoirs. Heavy oil extraction is mainly based on thermal oil extraction by steam injection, and it is accompanied by the generation of a large amount of high-temperature, high salt, high silica, and high organic matter-containing heavy oil produced water. After removing oil, suspended solids, silica and hardness, the heavy oil produced water is recycled for use in the steam injection boiler. This, on one hand, can save a lot of valuable water resources, and on the other hand can greatly reduce the heavy oil wastewater discharge on the environment. At the same time, it can make full use of the temperature of heavy oil wastewater (80-90° C.) to save the fuel for a steam injection boiler, and has significant economic, environmental and social benefits.

The silica content of heavy oil produced water is generally 100-300 mg/L. With the continuous thermal exploitation of heavy oil, the silica content of heavy oil extraction water gradually builds up. The SY/T6086-2012 technical specification for thermal recovery steam generator running has a water quality index requirement that the silica content of heavy oil produced water has to be reduced to less than 50 mg/L before it can be reused in a steam injection boiler. Currently, desilication is done by chemical removal processes such as warm lime, hot lime and sodium hydroxide, which share the common feature of desilication with magnesium agents. The so-called desilication with magnesium agents means that a chemical reaction is carried out by adding magnesium oxide or magnesium chloride to water under a certain pH condition (e.g., 9-11, and lime or sodium hydroxide are usually used for pH adjustment) to form flocculent substances such as magnesium carbonate or magnesium hydroxide which are used to adsorb soluble silicate compounds in the water to generate magnesium silicate precipitate, and the silicate compounds (commonly known as silica) are removed upon precipitation and discharge of sludge. Since the flocculent particles of magnesium carbonate, magnesium hydroxide and magnesium silicate are relatively small and light, it is usually necessary to further add polyaluminum and polyacrylamide so as to improve the precipitation efficiency, thereby increasing the particle size of the flocculent particles through an adsorptive and bridging effect, and facilitating settlement by gravity and shortening the precipitation time.

In the current technology for recycling heavy oil produced water for reuse in a steam injection boiler, the desilication with magnesium agents has the following disadvantages. 1) A lot of various types of reagents are added, which requires addition in large quantities of chemical reagents such as sodium hydroxide or lime, magnesium oxide or magnesium chloride, polyaluminum and polyacrylamide. 2) The reagents are added in relatively large amounts, and the cost of desilication is relatively high, with a cost of desilication agents of about 4-6 Chinese yuan for every cubic meter of heavy oil produced water, which adds a heavy economic burden to the enterprise. 3) Due to the addition of the various types of agents and the large amounts thereof, silica sludge is produced in a large amount, which accounts for approximately 10% of the water being treated, and such silica sludge is a hazardous waste because it contains some crude oil. The treatment cost is at least 1500 Chinese yuan for each ton of the hazardous waste, which brings heavy economic burden and pressure on production and operation. 4) Due to the addition of sodium hydroxide or lime, the pH of the water rises from about 7 to 9-11 and changes from neutral to strongly alkaline, and the nature of the water quality is changed significantly. The flocculent particles of the silica slurry are small and tend to flow with the water into the subsequent filtration system and softening system, resulting in hardening and scaling of filter materials and resin, which affects the normal operation of the filtration system and softening system.

Therefore, there is an urgent need for researching and developing a new technology for directly recycling highly silica-containing heavy oil produced water for reuse in a steam injection boiler without desilication.

### SUMMARY OF THE INVENTION

In order to solve the above problems, it is an object of the present disclosure to provide a method and a system for recycling heavy oil produced water for use in a steam injection boiler without desilication. This method is capable of lowering the concentration of divalent and trivalent scaling ions in the water to 50 μg/L or below without decrease in temperature, desilication, salt removal and organic matter removal, and also completely avoiding the problem of boiler scaling without lowering the silica concentration of the feed water.

In order to achieve the above object, the present disclosure provides a method for recycling heavy oil produced water for use in a steam injection boiler without desilication, comprising subjecting the heavy oil produced water sequentially to a pre-treatment, a filtration treatment, and an advanced treatment for removing divalent and trivalent scaling ions, wherein the treatment agent used in the advanced treatment for removing divalent and trivalent scaling ions comprises a macroporous weak acid resin, and the raw materials for the macroporous weak acid resin include a matrix material, a porogenic agent, a reinforcing agent, an initiator, and a dispersant in a mass ratio of (25-35):(32-50):(1-3):(0.8-1.2):(6-9).

In a specific embodiment of the present disclosure, the method described above comprises no desilication treatment of the heavy oil produced water. That is, no desilication agent is added during the entire process of treatment. In the conventional method of recycling produced water for use in a steam injection boiler, a desilication agent such as magnesium oxide or magnesium chloride is generally used to remove silica from the produced water after pre-treatment and before softening treatment, thereby reducing the silica content to prevent calcium and magnesium ions from forming a silica scale with silica that leads to scaling in the boiler furnace tube by the produced water. It is found in the present disclosure that the occurrence of boiler furnace tube scaling is mainly related closely to the operating pressure and temperature of the steam injection boiler itself, the dryness of the steam generated, the divalent and trivalent scaling ions in the water (Ca²⁺, Mg²⁺, Fe²⁺, Fe³⁺, Al³⁺, Ba²⁺, Sr³⁺, etc.), and the silica concentration in the water, but not just the hardness (Ca²⁺, Mg²⁺) and silica concentration. In the case where a stable pressure, temperature and dryness are kept constant during boiler operation, whether boiler scaling occurs or not is mainly related to the concentration of silica and that of divalent and trivalent scaling ions (Ca²⁺, Mg²⁺, Fe²⁺, Fe³⁺, Al³⁺, Ba²⁺, Sr³⁺, etc.). Further analysis of the composition of the boiler scale indicates that the furnace tube scaling scale is mainly acmite (NaBaFeAlSi₂O₆), andradite (Ca₃SrFe₂Si₃O₁₂) and tremolite (Ca₂Mg₅Si₈O₂₂(OH)₂). Regardless of the water quality conditions, there is more than silica scale alone present in a scale sample, suggesting that silica does not scale if it is not combined with other scaling ions such as Ca²⁺, Mg²⁺, Fe²⁺, Fe³⁺, Al³⁺, Ba²⁺, Sr³⁺, etc. This is a significant breakthrough in the understanding of the mechanism in boiler scaling. In this regard, by performing the “pilot test for reuse of high silica-containing heavy oil produced water in a steam injection boiler”, the present disclosure shows that the issue of scaling in the furnace tube of a steam injection boiler does not arise even with the silica concentration increased from 50 to 300 mg/L, as long as the divalent and trivalent scaling ions are thoroughly removed to a concentration of 50 μg/L or less. That is, it is possible to carry out only an advanced removal process of the divalent and trivalent scale ions, while eliminating the desilication process. By applying the above method of the present disclosure in oil fields, significant economic, environmental and social benefits can be achieved.

In the above method, the pre-treatment does not include a desilication treatment. The silica content in the heavy oil produced water after the advanced treatment of removing divalent and trivalent scaling ions is less than 300 mg/L, which is basically the same as the silica content in the typical water quality of heavy oil produced water (100-300 mg/L). That is, it can be done without desilication. The concentration of divalent and trivalent scaling ions in the heavy oil produced water after the advanced removal of divalent and trivalent scaling ions is reduced to 50 μg/L or less, that is, the concentration of divalent and trivalent ions such as Ca²⁺, Mg²⁺, Fe²⁺, Fe³⁺, Al³⁺, Ba²⁺, Sr³⁺, which tend to scale together with silica in the heavy oil produced water, is reduced to a trivial level. Therefore, although the silica content of the heavy oil produced water after being treated by the above method is high, no silica scale will be generated in the boiler. This in turn can raise the criterion of silica concentration in boiler feed water from below 50 mg/L to below 300 mg/L, which breaks through the current technical standard limit for recycling heavy oil produced water for use in a steam injection boiler.

Compared with a conventional strong acid resin that can only reduce the hardness (Ca²⁺, Mg²⁺) of the heavy oil produced water to 0.3-0.5 mg/L, the macroporous weak acid resin provided by the present disclosure can completely adsorb all the divalent and trivalent scaling ions in the heavy oil produced water. When the macroporous weak acid resin is used as a treatment agent for advanced removal of divalent and trivalent scaling ions in the above method for recycling heavy oil produced water for use in a steam injection boiler, the concentration of the divalent and trivalent scaling ions (Ca²⁺, Mg²⁺, Fe²⁺, Fe³⁺, Al³⁺, Ba²⁺, Sr³⁺, and the like) in the heavy oil produced water can be reduced to 50 μg/L or less. Under these concentration conditions of divalent and trivalent scaling ions, even if the concentration of silica is slightly higher (e.g., the silica content is higher than 100 mg/L, less than 300 mg/L), no boiler scaling occurs, or the scaling rate is equal to or lower than the scaling rate after desilication. Therefore, the method for recycling heavy oil produced water for use in a steam injection boiler provided by the present disclosure can omit a desilication treatment, which in turn requires no addition of a desilication agent such as a magnesium agent, saves the cost of adding the agent and the cost of treating silica sludge, thereby avoiding the problem of system scaling during filtration treatment and softening treatment caused by the addition of the magnesium agent, improving production efficiency, and reducing production and maintenance costs.

According to a specific embodiment of the present disclosure, in the above method, generally, the heavy oil produced water after the advanced treatment of removing divalent and trivalent scaling ions has an oil content of less than 2 mg/L, a suspended solids content of less than 2 mg/L, a silica content of less than 300 mg/L, a total soluble solid content of less than 7,000 mg/L, and a concentration of divalent and trivalent scaling ions of 50 μg/L or less.

According to a specific embodiment of the present disclosure, in the above method, the advanced treatment of removing divalent and trivalent scaling ions generally comprises a primary advanced treatment and a secondary advanced treatment in sequence, wherein the hardness of the heavy oil produced water after the primary advanced treatment is less than 5 mg/L, and the concentration of divalent and trivalent scaling ions in the heavy oil produced water after the secondary advanced treatment (Ca²⁺, Mg²⁺, Fe²⁺, Fe³⁺, Al³⁺, Ba²⁺, Sr³⁺, and the like) is 50 μg/L or less. The primary advanced treatment and secondary advanced treatment are generally carried out respectively by using the above-described macroporous weak acid resin as an advanced treatment agent.

According to a specific embodiment of the present disclosure, in the above method, the advanced treatment of removing divalent and trivalent scaling ions is carried out in an advanced treatment device. During the process of the advanced treatment of removing divalent and trivalent scaling ions, the working filtration rate of the macroporous weak acid resin in the advanced treatment device may be 20-30 m/h, for example 20-25 m/h. The loading height of the macroporous weak acid resin in the advanced treatment device may be 1-1.6 m, for example 1.4-1.6 m.

According to a specific embodiment of the present disclosure, in the method, the pre-treatment generally comprises an oil-removal buffer treatment, an inclined plate oil-removal treatment, and a flotation treatment in sequence.

According to a specific embodiment of the present disclosure, in the above method, the treatment of the oil-removal buffer treatment is generally controlled at 60-90° C. for a duration of 12 hours. Generally, the heavy oil produced water after the oil-removal buffer treatment has an oil content of less than 500 mg/L and a suspended matter content of less than 300 mg/L.

According to a specific embodiment of the present disclosure, in the above method, the inclined plate oil-removal may comprise the processes of rapid mixing, slow reaction and inclined plate precipitation. In the process of rapid mixing, the GT value of the stirring paddle for stirring may be greater than or equal to 1.5×10⁴, an oil-removing agent such as polymerized aluminum chloride may be used as an emulsion-breaking agent, and the dosage of the emulsion-breaking agent may be greater than or equal to 150 mg/L. In the process of slow reaction, the duration of the slow reaction is 15 minutes, and the GT value of the stirring paddle for stirring may be greater than or equal to 1×10⁴, and polyacrylamide or the like may be used as a coagulant aid, and the dosage of the coagulant aid may be 2-3 mg/L. In the process of inclined plate precipitation, the duration of the inclined plate precipitation is generally 1.5 hours.

According to a specific embodiment of the present disclosure, in the above method, generally, the heavy oil produced water after the inclined plate oil-removal treatment has an oil content of less than 50 mg/L and a suspended matter content of less than 100 mg/L.

According to a specific embodiment of the present disclosure, in the above method, the flotation treatment may comprise the processes of rapid mixing, slow reaction and flotation for removing impurities. In the process of rapid mixing, the duration of the rapid mixing may be 1 minute, and the GT value of the stirring paddle for rapid mixing may be 1.5×10⁴, an oil-removing agent such as polymerized aluminum chloride may be used as the emulsion-breaking agent, and the dosage of the emulsion-breaking agent may be 20 mg/L. In the process of slow reaction, the duration of the slow reaction may be 3 minutes, and the GT value of the stirring paddle used for the slow reaction may be 1×10⁴, polyacrylamide or the like may be used as a coagulant aid, and the dosage of the coagulant aid may be 1-2 mg/L. In the process of flotation for removing impurities, the duration of the flotation for removing impurities is generally 0.5 hour.

According to a specific embodiment of the present disclosure, in the above method, generally, the heavy oil produced water after the flotation treatment has an oil content of less than 10 mg/L, a suspended matter content of less than 20 mg/L, a silica content of less than 300 mg/L, and a total hardness of less than 200 mg/L.

According to a specific embodiment of the present disclosure, in the above method, generally, the heavy oil produced water after the filtration treatment has a total hardness of less than 200 mg/L, an oil content of less than 2 mg/L, a suspended matter content of less than 2 mg/L, a silica content of less than 300 mg/L, and a total soluble solid content of less than 7000 mg/L.

According to a specific embodiment of the present disclosure, in the above method, the filtration treatment may comprise a primary filtration treatment and a secondary filtration treatment in sequence. Generally, the heavy oil produced water after the primary filtration treatment has a total hardness of less than 200 mg/L, an oil content of less than 5 mg/L, a suspended matter content of less than 5 mg/L, a silica content of less than 300 mg/L, and a total soluble solid content of less than 7000 mg/L.

According to a specific embodiment of the present disclosure, the filtration treatment may further comprise a suction filtration treatment prior to the primary filtration treatment. The duration of the suction filtration treatment is generally controlled at 0.5 hour.

According to the specific embodiment of the present disclosure, in the process of the primary filtration treatment, anthracite, for example, can be used as a filter material. The normal filtration rate can be controlled at 13 m/h, the calibration filtration rate can be controlled at 15.6 m/h, and the working period can be controlled at 12 hours. The primary filtration treatment may include washing by means of gas-water combination and the like. The water washing intensity can be controlled at 13 L/s·m², and the water washing time can be controlled at 10 min; the gas washing intensity can be controlled at 16 NL/s·m², and the gas washing time can be controlled at 5 min.

According to a specific embodiment of the present disclosure, in the process of the secondary filtration treatment, anthracite and carborundum, for example, can be used as the filter material. The normal filtration speed can be controlled at 7.8 m/h, the calibration filtration speed can be controlled at 8.7 m/h, and the working period can be controlled at 24 hours. The primary filtration treatment may include washing by means of gas-water combination and the like. The water washing intensity can be controlled at 13 L/s·m², and the water washing time can be controlled at 10 min; the gas washing intensity can be controlled at 16 NL/s·m², and the gas washing time can be controlled at 5 min.

In a specific embodiment of the present disclosure, a macroporous weak acid resin for performing the advanced treatment of removing divalent and trivalent scaling ions has the following characteristics:
1) The macroporous weak acid resin can withstand high temperature of 95° C. or more (preferably 95-120° C.), and can maintain structural integrity and not broken under high temperature conditions. It does not need to be cooled down during the advanced treatment of removing divalent and trivalent scaling ions, and has a long service life.
2) The macroporous weak acid resin has both of a high mechanical strength of 290-310 N/mm² and a large pore size of 800-900 nm, as well as a pore area of 800-1200 m²/g. Organic molecules with larger diameter can pass through the pores of the macroporous weak acid resin, and therefore it is favorable for the adsorption and desorption of organic substances, thereby effectively preventing the pollution by organic substances.
3) With a high exchange capacity of up to 3.9-4.1 mmol/ml, this macroporous weak acid resin can simultaneously adsorb a large number of divalent and trivalent scaling ions (Ca²⁺, Mg²⁺, Fe²⁺, Fe³⁺, Al³⁺, Ba²⁺, Sr³⁺) and a small amount of organic matter. This not only reduces the concentration of divalent and trivalent scaling ions in the heavy oil produced water to 50 μg/L or below, but also saves the use of an agent for removing organic matters. Therefore, it is possible to realize the advanced treatment of removing all the divalent and trivalent scaling ions (Ca²⁺, Mg²⁺, Fe²⁺, Fe³⁺, Al³⁺, Ba²⁺, Sr³⁺) from the heavy oil produced water without removing the salts and organic matters in advance.
4) This macroporous weak acid resin can be regenerated after saturation or poisoning. By desorption of the inorganic salt ions (Ca²⁺, Mg²⁺, Fe²⁺, Fe³⁺, Al³⁺, Ba²⁺, Sr³⁺, and the like) and large organic molecules adsorbed in the resin by sequentially conducting an acid regeneration and an alkaline transformation, the exchange capacity of the macroporous weak acid resin can be maintained, while removing the contaminants from the pores and restoring its activity, which is characteristic in its renewability and recyclability.

According to a specific embodiment of the present disclosure, in the macroporous weak acid resin, the porogenic agent can form a large number of capillary channels inside the macroporous weak acid resin, divide the polymer formed by the matrix material into heterogeneous gel structures and further form gel pores and capillary pores (generally having a pore volume of about 0.5 ml/g, and a pore size of 20-100 nm) inside the resin, enlarging the pore size of the macroporous weak acid resin, increasing the channel area, accelerating the ion exchange reaction rate, and increasing the exchange capacity. This can not only improve the adsorption capacity for divalent and trivalent scaling ions (Ca²⁺, Mg²⁺, Fe²⁺, Fe³⁺, Al³⁺, Ba²⁺, Sr³⁺), but the large pore size structure of the macroporous weak acid resin can also allow organic molecules with a large diameter to pass through. During the adsorption, the adsorption capacity of the macroporous weak acid resin for Ca²⁺, Mg²⁺, Fe²⁺, Fe³⁺, Al³⁺, Ba²⁺, Sr³⁺ in the water is much greater than that for organic matters, so the adsorption process for divalent and trivalent scaling ions will not be disturbed by the adsorption process for organic matters. In addition, the macroporous weak acid resin exhibits a certain shrinkage and expansion capacity in an acid solution and an alkali solution, and allows the adsorption and desorption of divalent and trivalent scaling ions and organic molecules in the macroporous weak acid resin and improve the anti-pollution ability of the macroporous weak acid resin. In some specific embodiments, the porogenic agent may be one or a combination of two or more of toluene, xylene, polyethylene glycol, and hydroxypropyl cellulose.

According to a specific embodiment of the present disclosure, in the macroporous weak acid resin, the reinforcing agent can increase the crosslinking degree of the macroporous weak acid resin, thereby greatly improving the mechanical strength and high temperature resistance of the macroporous weak acid resin. In some embodiments, the macroporous weak acid resin may have a mechanical strength of 290-310 N/mm², and can withstand high temperature of 95° C. or higher (in some specific embodiments, the high temperature resistance can be 95-120° C.), which is much superior to conventional resins. In some specific embodiments, the reinforcing agent may include acrylonitrile and/or isobutyronitrile.

The present disclosure has found through research that an excessively small pore size of the macroporous weak acid resin cause its exchange capacity to be too small, and the effect of the advanced removal of divalent and trivalent scaling ions is insignificant; an excessively large pore size of the macroporous weak acid resin will deteriorate its mechanical properties, and make the resin brittle. By controlling the amount of the porogenic agent and the reinforcing agent within an appropriate range in the present disclosure, it is possible to have high mechanical properties and improve the temperature resistance, while expanding the pore size of the macroporous weak acid resin and obtaining a large exchange capacity and anti-pollution ability. The mass ratio of the porogenic agent to the reinforcing agent is generally controlled to (32-50):(1-3), for example 40:2. In some specific embodiments, the amount of the porogenic agent and the reinforcing agent added in the raw materials for the macroporous weak acid resin can be controlled as follows: the mass ratio of the matrix material, the porogenic agent, the reinforcing agent, the imitator, and the dispersant is 30:(40-50):(1-2):1:(7-8).

According to a specific embodiment of the present disclosure, in the macroporous weak acid resin, the matrix material may include an acrylate-based compound. The acrylate-based compound may include one or a combination of two or more of methyl acrylate, ethyl acrylate, methyl 2-methacrylate and ethyl 2-methacrylate.

According to a specific embodiment of the present disclosure, in the macroporous weak acid resin, the initiator may include AIBN (azobisisobutyronitrile) and/or BPO (dibenzoyl peroxide).

According to a specific embodiment of the present disclosure, in the macroporous weak acid resin, the dispersant may include one or a combination of two or more of polyvinyl alcohol, gelatin, and carboxymethyl cellulose.

In a specific embodiment of the present disclosure, the raw materials for the macroporous weak acid resin may further include a crosslinking agent.

According to a specific embodiment of the present disclosure, in the macroporous weak acid resin, the crosslinking agent may include divinylbenzene and the like.

In a specific embodiment of the present disclosure, the mass ratio of the matrix material to the crosslinking agent is generally 25-35:15-25, for example, it may be 30:20.

In some specific embodiments, the matrix material, the porogenic agent, the reinforcing agent, the crosslinking agent, the initiator and the dispersant may be in a mass ratio of 30:(40-50):(1-2):20:1:(7-8).

In a specific embodiment of the present disclosure, the raw materials for the macroporous weak acid resin may include by mass: 25-35 parts of a matrix material (generally an acrylate-based compound, for example, one or a combination of two or more of methyl acrylate, ethyl acrylate, methyl 2-methacrylate and ethyl 2-methacrylate), 32-50 parts of a porogenic agent (for example, one or a combination of two or more of toluene, xylene, polyethylene glycol and hydroxypropyl cellulose), 1-3 parts of a reinforcing agent (acrylonitrile and/or isobutyronitrile), 15-25 parts of a crosslinking agent (divinylbenzene and the like), 0.8-1.2 parts of an initiator (AIBN and/or BPO) and 6-9 parts of a dispersant. Preferably, the raw materials for the macroporous weak acid resin include by mass: 30 parts of a matrix material, 32-46 parts or 30-parts (preferably 40 parts) of a porogenic agent, 1-2 parts of a reinforcing agent, 20 parts of a crosslinking agent, 1 part of an initiator, and 7-8 parts of a dispersant.

According to a specific embodiment of the present disclosure, the macroporous weak acid resin is prepared by a process generally comprising: mixing the raw materials for the macroporous weak acid resin (including a matrix material, a porogenic agent, a reinforcing agent, a dispersant, an initiator, and optionally a crosslinking agent) and then carrying out a suspension polymerization to obtain resin beads; and subjecting the resin beads to hydrolysis to obtain the macroporous weak acid resin.

According to a specific embodiment of the present disclosure, in the preparation method of the macroporous weak acid resin, the reaction temperature for the suspension polymerization is generally controlled at 70-95° C. (for example, 85° C., 90° C.), and the reaction time is generally controlled at 7-10 hours (preferably 7-9 hours, for example 8 hours), and the reaction pressure is generally ambient pressure.

According to a specific embodiment of the present disclosure, in the preparation method of the macroporous weak acid resin, during the hydrolysis, the porogenic agent can be evaporated with water, thereby forming a large number of capillary channels in the resin beads, and expanding the pore size and channel area of the macroporous weak acid resin. The hydrolysis temperature is generally 100° C., and the hydrolysis time is generally 1 hour.

In a specific embodiment of the present disclosure, the macroporous weak acid resin may be prepared by a method including: mixing a matrix material, a porogenic agent and a reinforcing agent, and then adding thereto a crosslinking agent, an initiator and a dispersant, and carrying out suspension polymerization at 70-95° C. under ambient pressure for 7-10 hours to obtain resin beads; then hydrolyzing the resin beads at 100° C. for 1 hour to obtain the macroporous weak acid resin.

Compared to commonly used water treatment agents such as strong acid resins, the macroporous weak acid resin used in the present disclosure, after being saturated and poisoned, can be desorbed off the inorganic and organic impurities in its pores through a regeneration process to avoid contamination by organic impurities. This regeneration process allows the exchange capacity of the macroporous weak acid resin to fully recover.

According to a specific embodiment of the present disclosure, in the above method, when the hardness of the heavy oil produced water after the primary advanced treatment is greater than 5 mg/L, or when the concentration of divalent and trivalent scaling ions of the heavy oil produced water after the secondary advanced treatment is greater than 50 μg/L (the macropore resin is considered to be ineffective due to saturation or poisoning in both cases), the above method may accordingly further include a process of regenerating the macroporous weak acid resin used in the primary advanced treatment or the secondary advanced treatment. The regeneration process of the macroporous weak acid resin generally comprises: soaking the macroporous weak acid resin in an acid solution and an alkaline solution in sequence, until the concentration of divalent and trivalent scaling ions in the heavy oil produced water after being treated with the regenerated macroporous weak acid resin reaches 50 μg/L or less. When the concentration of divalent and trivalent scaling ions in the produced water after being treated is more than 50 μg/L, the above regeneration process is repeated until the concentration of divalent and trivalent scaling ions in the heavy oil produced water after being treated with the regenerated macroporous weak acid resin reaches 50 μg/L or less.

During the above regeneration process, the soaking time of the macroporous weak acid resin in the acid solution and the alkaline solution is generally determined according to the shrinkage and expansion of the resin. Specifically, the macroporous weak acid resin is generally soaked in the acid solution until the resin height is reduced by 30%. For example, the soaking time of the macroporous weak acid resin in the acid solution is generally controlled at ≥1 hour. It is soaked in the alkali solution until the resin height is increased by 65%. For example, the soaking time in the alkali solution is generally controlled at ≥1.5 hour.

In a specific embodiment of the present disclosure, when the macroporous weak acid resin used in the primary advanced treatment or the secondary advanced treatment is poisoned or saturated, after the regeneration treatment of the inactivated macroporous weak acid resin, the advanced treatment device loaded with non-inactivated macroporous weak acid resin can be used as a primary advanced treatment device, and the advanced treatment device loaded with the macroporous acid resin regenerated after being inactivated can be used as a secondary advanced treatment device.

According to a specific embodiment of the present disclosure, during the above regeneration process, upon soaking of the macroporous weak acid resin in an acid solution, the divalent and trivalent scaling ions adsorbed by the resin can be displaced, and at this time the macroporous weak acid resin is transformed from a Na type to an H type. Upon soaking of the resin layer in an alkaline solution, the macroporous weak acid resin is again transformed from the H-type to the Na-type, so that the influence on the quality of the heavy oil produced water treated with the macroporous weak acid resin is avoided. In addition, soaking of the resin layer in an acid solution allows the macroporous weak acid resin to shrink, while soaking of the resin layer in an alkaline solution allows the macroporous weak acid resin to expand, and the process of the shrinking and expanding can facilitate the extraction of divalent and trivalent scaling ions and organic matters adsorbed by the macroporous weak acid resin, maintaining the exchange effect of the resin and prolonging the service life of the resin.

According to a specific embodiment of the present disclosure, the above regeneration process may further include a process of washing with softened water (water with a divalent and trivalent scaling ion concentration of 50 μg/L or less) before acid soaking and/or after alkaline soaking, so as to remove impurities such as suspended matters adsorbed in the macroporous weak acid resin.

According to a specific embodiment of the present disclosure, the degree of regeneration of the macroporous weak acid resin is generally tested with the heavy oil produced water. Specifically, the macroporous weak acid resin is used for advanced removal of divalent and trivalent scaling ions from untreated heavy oil produced water, and when the concentration of the divalent and trivalent scaling ions in the treated heavy oil produced water reaches 50 μg/L or less, it is confirmed that the exchange capacity of the macroporous weak acid resin is fully restored, and the regeneration process is completed.

In the above regeneration process, preferably, the acid solution has a pH≤2 and the alkaline solution has a pH≥13. The acid solution may be hydrochloric acid with a mass concentration of 3-5% and the like, and the alkaline solution may be a sodium hydroxide solution with a mass concentration of 3-5% and the like.

The present disclosure also provides a system for recycling heavy oil produced water for use in a steam injection boiler without desilication, which comprises a pre-treatment system, a filtration system and an advanced treatment system connected in sequence. The system for recycling heavy oil produced water for use in a steam injection boiler is capable of implementing the method for recycling heavy oil produced water for use in a steam injection boiler without desilication as described above.

In a specific embodiment of the present disclosure, the advanced treatment system is generally loaded with a macroporous weak acid resin, e.g., the macroporous weak acid resin used in the method described above, to remove divalent and trivalent scaling ions from the heavy oil produced water.

According to a specific embodiment of the present disclosure, the system for recycling heavy oil produced water for use in a steam injection boiler without desilication is capable of implementing the method for recycling heavy oil produced water for use in a steam injection boiler without desilication as described above.

According to a specific embodiment of the present disclosure, the pre-treatment system is used to first pre-treat the heavy oil produced water. In a specific embodiment, the pre-treatment system may comprise an oil-removal buffer tank, inclined plate oil-removal tank and a DAF flotation machine connected in sequence, which are used for oil-removal buffer treatment, inclined plate oil-removal treatment, and flotation treatment, respectively. The inclined plate oil-removal tank may further include a fast mixing tank, a slow reaction tank, and an inclined plate precipitation tank; and the DAF flotation machine may further comprise a fast mixing tank, a slow reaction tank and a flotation machine. In some specific embodiments, the flotation machine may comprise an air compressor, a pressure gas dissolution tank, a releaser, a flotation zone, a floating sludge scraper and the like. The air compressor is used for compressing air into water in a pressure gas dissolution tank to mix and form air-dissolved water at a certain pressure which is generally controlled at 0.3-0.5 MPa. The releaser is used for releasing the air dissolved in the air-dissolved water in the flotation machine to form emulsion-like bubbles with a diameter of about 30 micrometers. These bubbles with very small diameters in tremendous numbers are combined and float together with the oil and suspended matters in the heavy oil produced water under the action of buoyancy force to form a floating sludge. The floating sludge is removed by a scraper, and the heavy oil produced water entered in the flotation machine is further purified.

According to specific embodiments of the present disclosure, the pre-treatment system may further comprise a suction filtration tank. In a specific embodiment, the inlet of the suction filtration tank is generally connected to the outlet of the DAF flotation machine.

According to a specific embodiment of the present disclosure, the filtration system is used to filter the heavy oil produced water after the pre-treatment. In a specific embodiment, the filtration system generally comprises a primary filter for primary filtration treatment and a secondary filter for secondary filtration treatment connected to each other. The inlet of the primary filter is generally connected to the outlet of the pre-treatment system, and when the pre-treatment system comprises an oil-removal buffer tank, an inclined plate oil-removal tank and a DAF flotation machine connected in sequence, the inlet of the primary filter may be connected to the outlet of the DAF flotation machine; and when the pre-treatment system further comprises a suction filtration tank, the outlet of the suction filtration tank may be connected to the inlet of the primary filter.

According to a specific embodiment of the present disclosure, the advanced treatment system is used for advanced removal of divalent and trivalent scaling ions from heavy oil produced water. In a specific embodiment, the advanced treatment generally comprises a primary advanced treatment device for primary advanced treatment and a secondary advanced treatment device for secondary advanced treatment. The inlet of the primary advanced treatment device is generally connected to the outlet of the filtration system, and when the filtration system comprises the primary filter and the secondary filter, the inlet of the primary advanced treatment device is generally connected to the outlet of the secondary filter.

According to a specific embodiment of the present disclosure, by connecting the outlet of the advanced treatment system (the outlet of the secondary advanced treatment device) to an external water delivery tank, and the treated heavy oil produced water can be sent by external delivery via a pump to a steam boiler.

The present disclosure has the following beneficial effects:
1) The method for recycling heavy oil produced water for use in a steam injection boiler provided by the present disclosure does not require the addition of a desilication agent. Only by reducing the concentration of divalent trivalent scaling ions (Ca²⁺, Mg²⁺, Fe²⁺, Fe³⁺, Al³⁺, Ba²⁺, Sr³⁺, and the like) in the heavy oil produced water to 50 μg/L or less, it is possible to ensure that no scaling problem occurs when the heavy oil produced water is reused in a steam injection boiler even with a high silica content, thus ensuring safe operation of the boiler.
2) Since there is no need to add a desilication agent, the above method provided by the present disclosure is able to effectively avoid the problem of boiler scaling, and to solve the problems of the high costs for the investment in the high dosage of the agents added and the addition thereof, silica sludge treatment and desilication unit and auxiliary facilities (reagent addition system and silica sludge treatment system), and severe scaling of the subsequent filtration system and softening system, and the like.
3) The above method provided by the present disclosure significantly lowers the requirement of the content of silica in the produced water for reuse in the steam injection boiler. It breaks through the limitation in the prior art, realizes the recycling of highly silica-containing heavy oil produced water for use in a steam injection boiler, and has significant economic, environmental and social benefits.

### BRIEF DESCRIPTION OF DRAWINGS

FIG. 1 shows a structural diagram of the system for recycling heavy oil produced water for use in a steam injection boiler of Example 1.

FIG. 2 shows a workflow chart of the steam injection boiler system of Example 2.

FIG. 3 shows a structural diagram of the system for recycling heavy oil produced water for use in a steam injection boiler of Comparative Example 1.

FIG. 4 shows a flow chart of the desilication treatment in Comparative Example 1.

FIG. 5 shows a photograph of the tube walls of the steam injection boiler using recycled highly silicon-containing wastewater and the steam injection boiler using recycled wastewater upon desilication in Test Example 1.

### DESCRIPTION OF REFERENCE NUMBERS OF MAJOR COMPONENTS

Oil-removal buffer tank 1-1, inclined plate oil-removal tank 1-2, DAF flotation machine 1-3, suction filtration tank 1-4, primary filter 1-5, secondary filter 1-6, primary advanced treatment device 1-7, secondary advanced treatment device 1-8, primary softening treatment device 1-7a, secondary softening treatment device 1-8a, external water delivery tank 1-9, desilication unit 1-10, plunger pump 2-1, heat exchanger 2-2, convection section 2-3, radiation section 2-4, combustor 2-5.

### DETAILED DESCRIPTION OF THE INVENTION

For a clearer understanding of the technical features, purposes and beneficial effects of the present disclosure, the technical solutions of the present disclosure will now be described below in details, but it should not be construed as limiting the implementable scope of the present disclosure.

Experiments 1 to 6 provide a series of macroporous weak acid resins.

### Experiment 1

This experiment provides a macroporous weak acid resin prepared by a method comprising:
first mixing 30 parts by mass of methyl acrylate and ethyl acrylate in a mass ratio of 2:1, parts by mass of toluene and xylene in a mass ratio of 1:1, and 2 parts by mass of acrylonitrile and isobutyronitrile in a mass ratio of 10:1, then adding thereto 20 parts by mass of divinylbenzene, 1 part by mass of gelatin and polyvinyl alcohol in a mass ratio of 20:1, 7 parts by mass of carboxymethyl cellulose, and 0.8 parts by mass of AIBN and BPO in a mass ratio of 1:2, and mixing them to obtain the raw materials for the macroporous weak acid resin;
subjecting the raw materials for the macroporous weak acid resin to suspension polymerization at 90° C. under ambient pressure for 9 hours to obtain resin beads; hydrolyzing the resin beads at 100° C. for 1 hour to obtain a macroporous weak acid resin.

### Experiment 2

This experiment provides a macroporous weak acid resin prepared by a method comprising:
mixing 30 parts by mass of methyl acrylate, 50 parts by mass of toluene, and 2 parts by mass of acrylonitrile, then adding thereto 20 parts by mass of divinylbenzene, 1 part by mass of gelatin and polyvinyl alcohol in a mass ratio of 10:1, 8 parts by mass of carboxymethyl cellulose, and 1 part by mass of AIBN and BPO in a mass ratio of 1:2, and mixing them to obtain the raw materials for the macroporous weak acid resin;
subjecting the raw materials for the macroporous weak acid resin to suspension polymerization at 85° C. under ambient pressure for 8 hours to obtain resin beads; hydrolyzing the resin beads at 100° C. for 1 hour to obtain a macroporous weak acid resin.

### Experiment 3

This experiment provides a macroporous weak acid resin prepared by a method which is substantially the same as the preparation method of the macroporous weak acid resin in Example 1, except that the total parts by mass of toluene and xylene as the porogenic agent was increased to 50 parts in this example, with the other raw material components and amounts thereof remaining unchanged.

### Experiment 4

This experiment provides a macroporous weak acid resin prepared by a method which is substantially the same as the preparation method of the macroporous weak acid resin in Example 1, except that the parts by mass of acrylonitrile and isobutyronitrile as the reinforcing agent is reduced to 1 part in this example, with the other raw material components and amounts thereof remaining unchanged.

### Experiment 5

This experiment provides a macroporous weak acid resin prepared by a method which is substantially the same as the preparation method of the macroporous weak acid resin in Example 1, except that the suspension polymerization reaction was carried out at a temperature of 75° C. for 10 hours in this example, with the composition of the raw materials remaining unchanged.

### Experiment 6

This experiment provides a macroporous weak acid resin prepared by a method comprising:
mixing 20 parts by mass of methyl acrylate and ethyl acrylate in a mass ratio of 1:1, 30 parts by mass of toluene and xylene in a mass ratio of 1:1, and 2 parts by mass of acrylonitrile and isobutyronitrile in a mass ratio of 5:1, then adding thereto 40 parts by mass of divinylbenzene, 5 parts by mass of gelatin and polyvinyl alcohol in a mass ratio of 5:1, 1 part by mass of carboxymethyl cellulose, and 1.2 parts by mass of AIBN and BPO in a mass ratio of 1:2, and mixing them to obtain the raw materials for the macroporous weak acid resin;
subjecting the raw materials for the macroporous weak acid resin to suspension polymerization at 90° C. under ambient pressure for 9 hours to obtain resin beads; hydrolyzing the resin beads at 100° C. for 1 hour to obtain a macroporous weak acid resin.

The macroporous weak acid resins in Experiments 1 to 6 and commercially available conventional macroporous weak acid resin (manufacturer: Rohm&Haas, model: D113) were tested for performance. The test methods for exchange capacity, pore size, channel area, high temperature resistance and mechanical strength were carried out in accordance with the standards GB8144-1987 “Determination for exchange capacity of cation exchange resins”, GB/T 21650.2-2008 “Pore size distribution and porosity of solid materials by mercury porosimetry and gas adsorption”, and “Determination for heat resistance of strongly basic anion exchange resins used in water treatment DL/T771—2001 Appendix C”. The test results are summarized in Table 1.

TABLE 1

| | | | | High | |
|---|---|---|---|---|---|
| | Exchange | Pore | Channel | temperature | Mechanical |
| | capacity | size | area | resistance | strength |
| Resin No. | (mmol/mL) | (nm) | (m²/g) | (° C.) | (N/mm²) |
| Experiment 1 | 4.1 | 800-900 | 1200 | 120 | 300 |
| Experiment 2 | 3.9 | 900-1000 | 1300 | 115 | 290 |
| Experiment 3 | 3.9 | 900-1000 | 1300 | 115 | 290 |
| Experiment 4 | 4.0 | 800-900 | 1200 | 118 | 310 |
| Experiment 5 | 4.1 | 800-900 | 1200 | 120 | 300 |
| Conventional | 2.3 | 400-600 | 800 | 80 | 120 |
| macroporous | | | | | |
| weak acid | | | | | |
| resin | | | | | |
| Experiment 6 | 2.1 | 200-300 | 600 | 80 | 96 |

It can be seen from Table 1 that the exchange capacity, pore size, channel area, high temperature resistance and mechanical strength of the macroporous weak acid resins of Experiments 1 to 5 are all higher than those of the conventional macroporous weak acid resin and the resin of Experiment 6. Specifically:
(1) The data of exchange capacity, pore size, and channel area indicate that the macroporous weak acid resin used in the present disclosure has higher inorganic ion adsorption capacity, especially the ability to remove divalent and trivalent scaling ions.
(2) The high temperature resistance and mechanical strength indicate that the macroporous weak acid resin of the present disclosure is suitable for the process of removing divalent and trivalent scaling ions at high temperature, has a structure not easy to break and a longer service life.
(3) In addition, it is also determined that the macroporous weak acid resins of Experiments 1 to 5 can reduce the organic matters in the heavy oil produced water from an average COD of 350 mg/L to an average COD of 300 mg/L, suggesting that the macroporous weak acid resins provided by the present disclosure has a certain adsorption capacity for organic impurities.

In contrast, the commercially available conventional macroporous weak acid resin and the macroporous weak acid resin of Experiment 6 cannot withstand the heavy oil produced water at a maximum temperature of 90° C., and cannot carry out the process of removing divalent and trivalent scaling ions without cooling down. The exchange capacity of the commercially available conventional macroporous weak acid resin is only about 60% of that of the macroporous weak acid resin of the present disclosure, the pore size and channel area thereof is about 50% of those of the macroporous weak acid resin of the present disclosure, the mechanical strength thereof is 40% of that of the macroporous weak acid resin of the present disclosure, and the adsorption capacity of inorganic and organic impurities and the service life are much lower than those of the macroporous weak acid resin of the present disclosure.

### Example 1

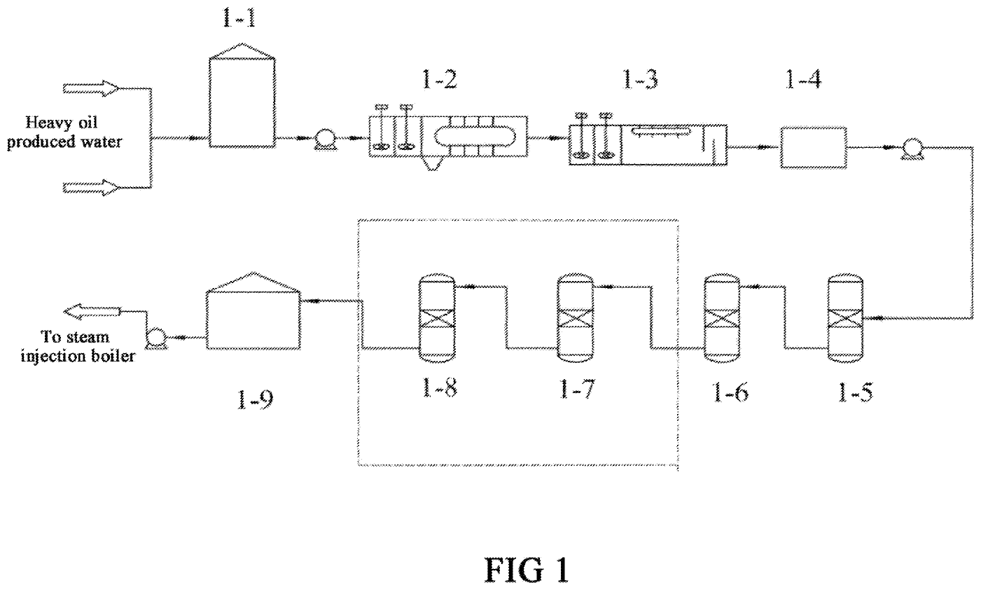

This example provides a system for recycling heavy oil produced water for use in a steam injection boiler without desilication, and FIG. 1 shows a schematic diagram of the structural connection of the system. Specifically, this system comprises an oil-removal buffer tank 1-1, an inclined plate oil-removal tank 1-2, a DAF flotation machine 1-3, a suction filtration tank 1-4, a primary filter 1-5, a secondary filter 1-6, a primary advanced treatment device 1-7, a secondary advanced treatment device 1-8, and an external water delivery tank 1-9 connected in sequence.

The inclined plate oil-removal tank 1-2 comprises a fast mixing tank, a slow reaction tank, and an inclined plate precipitation tank connected in sequence. The fast mixing tank and the slow reaction tank are provided with stirring paddles respectively.

The DAF flotation machine 1-3 comprises a fast mixing tank, a slow reaction tank, and a flotation machine. The fast mixing tank and the slow reaction tank are provided with stirring paddles respectively. The flotation machine comprises an air compressor, a pressure gas dissolution tank, a releaser, a flotation zone, and a floating sludge scraper. The air compressor is used for compressing air into a pressure gas dissolution tank where it is mixed with water to form air-dissolved water at a certain pressure. The releaser is used to release the air dissolved in the air-dissolved water to the heavy oil extraction water in the flotation machine, to form fine emulsion-like air bubbles in large quantities in the heavy oil produced water. The floating sludge scraper is used to remove the floating sludge formed from the air bubbles together with the oil and the suspended matter in the heavy oil produced water, so as to purify the heavy oil produced water.

Each of the primary advanced treatment device 1-7 and the secondary advanced treatment device 1-8 is loaded with a macroporous weak acid resin having a height of 1.4 m. The external water transfer tank 1-9 is used to collect the treated heavy oil produced water and deliver it to the steam injection boiler.

The outlet of the oil-removal buffer water tank 1-1 is connected to the inlet of the fast mixing tank in the inclined plate oil-removal tank 1-2; the outlet of the inclined plate precipitation tank in the inclined plate oil-removal tank 1-2 is connected to the inlet of the fast mixing tank in the DAF flotation machine 1-3; the outlet of the inclined plate precipitation tank in the DAF flotation machine 1-3 is connected to the inlet of the suction filtration tank 1-4; the outlet of the suction filtration tank 1-4 is connected to the inlet of the primary filter 1-5; the outlet of the primary filter 1-5 is connected to the inlet of the secondary filter 1-6; the outlet of the secondary filter 1-6 is connected to the inlet of the primary advanced treatment device 1-7; the outlet of the primary advanced treatment device 1-7 is connected to the inlet of the secondary advanced treatment device 1-8; the outlet of the secondary advanced treatment device 1-8 is connected to the inlet of the external water deliver tank 1-9; the external water deliver tank 1-9 is connected to the inlet of the steam injection boiler.

The macroporous weak acid resin loaded in the primary advanced treatment device 1-7 and the secondary advanced treatment device 1-8 in this example was prepared as follows:

30 parts by mass of methyl acrylate and ethyl acrylate in a mass ratio of 2:1, 40 parts by mass of toluene and xylene in a mass ratio of 1:1, 2 parts by mass of acrylonitrile and isobutyronitrile in a mass ratio of 10:1 was first mixed, and then 20 parts by mass of divinylbenzene, 1 parts by mass of gelatin and polyvinyl alcohol in a mass ratio of 20:1 and 7 parts of carboxymethyl cellulose and 0.8 parts by mass of AIBN and BPO in a mass ratio of 1:2 were added thereto and mixed to obtain macroporous weak acid resin raw materials. The macroporous weak acid resin raw materials were suspension polymerized at 90° C. for 9 h at atmospheric pressure to obtain resin beads. The resin beads were hydrolyzed at 100° C. for 1 h to obtain the macroporous weak acid resin.

### Example 2

This example provides a method for recycling heavy oil produced water for use in a steam injection boiler without desilication, which is to be performed in the system provided in Example 1. The method comprises an advanced treatment of removing divalent and trivalent scaling ions using the macroporous weak acid resin prepared in Example 1.

Specifically, the method for recycling heavy oil produced water for use in a steam injection boiler provided in the example includes the following procedures:

I. Pre-treatment:
1. Oil-removal buffer treatment: Heavy oil produced water were subjected to adjustment of water quality and quantity at 60-90° C. for 12 h. By controlling the liquid level, the floating heavy oil can be recovered and then dehydrated. The heavy oil produced water after the treatment had an oil content controlled at 500 mg/L or less, and a suspended matter content controlled at 300 mg/L or less.

The above oil-removal buffer treatment can be carried out in the oil-removal buffer tank 1-1.
2. Inclined plate oil-removal treatment:
(1) Fast mixing treatment: The heavy oil produced water after the oil-removal buffer treatment was subjected to a fast mixing treatment for 5 min. During the treatment process, an oil-removal agent, such as polymerized aluminum chloride, was added to the heavy oil produced water as an emulsion-breaking agent, and the amount added was controlled at 150 mg/L. At the same time, a stirring paddle was used to stir the heavy oil produced water, and the GT value of the stirring paddle was controlled at 1.5×10⁴.

In some specific embodiments, the above fast mixing treatment was carried out in the fast mixing tank in the inclined plate oil-removal tank 1-2.
(2) Slow reaction treatment: The heavy oil produced water after the fast mixing treatment was subjected to a slow reaction treatment for 15 min During the treatment, polyacrylamide, for example, was added to the heavy oil produced water as a coagulant, and the amount added was controlled at 2-3 mg/L. At the same time, a stirring paddle was used to stir the heavy oil produced water, and the GT value of the stirring paddle was controlled at 1.5×10⁴.

The above slow reaction treatment was carried out in the slow mixing tank in the inclined plate oil-removal tank 1-2.
(3) Inclined plate precipitation treatment: The heavy oil produced water after the slow reaction treatment was subjected to an inclined plate precipitation treatment for 1.5 h.

The above inclined plate precipitation treatment was carried out in the inclined plate precipitation tank in the inclined plate oil-removal tank 1-2.

The heavy oil produced water after the inclined plate precipitation treatment had an oil content controlled at 50 mg/L or less, and a suspended matter content controlled at 100 mg/L or less.
3. Flotation treatment:
(1) Fast mixing treatment: The heavy oil produced water after the inclined plate precipitation treatment was subjected to a fast mixing treatment for 1 min During the treatment, an oil-removal agent, such as polymerized aluminum chloride, was added to the heavy oil produced water as an emulsion-breaking agent, and the amount added was controlled at 20 mg/L. At the same time, a stirring paddle was used to stir the heavy oil produced water, and the GT value of the stirring paddle was controlled at 1.5×10⁴.

The above fast mixing treatment may be carried out in the fast mixing tank in the DAF flotation machine 1-3.
(2) Slow reaction treatment: The heavy oil produced water after the fast mixing treatment was subjected to a slow reaction treatment for 3 min. During the treatment, polyacrylamide, for example, was added to the heavy oil produced water as a coagulant, and the amount added was controlled at 1-2 mg/L. At the same time, a stirring paddle was used to stir the heavy oil produced water, and the GT value of the stirring paddle was controlled at 1×10⁴.

The above slow reaction treatment may be carried out in the slow mixing tank in the DAF flotation machine 1-3.
(3) Flotation and impurity removal treatment: The heavy oil produced water after the slow reaction treatment was subjected to a flotation and impurity removal treatment for 0.5 h. Compressed air and water were mixed to form air-dissolved water at a certain pressure (generally, 0.3-0.5 MPa). The air dissolved in the air-dissolved water was released in the heavy oil produced water to form a large number of emulsion-like air bubbles with a diameter of about micrometers. The air bubbles combined and floated together with the oil and suspended matter in the water under the action of buoyancy force to form a floating sludge. The floating sludge was removed, and the heavy oil produced water was thus purified.

The heavy oil produced water after the flotation and impurity removal treatment had an oil content controlled at 10 mg/L or less, a suspended matter content controlled at 20 mg/L or less, a total hardness of 200 mg/L or less, and a silica content controlled at 300 mg/L or less.

The above flotation treatment may be carried out in the flotation machine in the DAF flotation machine 1-3.

II. Filtration Treatment:
4. Suction filtration treatment: The heavy oil produced water after the flotation treatment was subjected to a suction filtration treatment for 0.5 h. The suction filtration treatment may be carried out in the suction filtration tank 1-4.
5. Primary filtration treatment: The heavy oil produced water after the suction filtration treatment was subjected to a primary filtration treatment, wherein anthracite was used as a filter material; the normal filtration rate was 13 m/h; the calibration filtration rate was 15.6 m/h; and the working period was 12 hours. The backwashing was a gas-water combined backwashing, wherein the water washing intensity was 13 L/s·m², and the water washing time was 10 min; the gas washing intensity was 16 NL/s·m², and the gas washing time was 5 min.

The heavy oil produced water after the primary filtration treatment had an oil content of less than 5 mg/L, a suspended matter content of less than 5 mg/L, a silica content of less than 300 mg/L, a total hardness of less than 200 mg/L, and a total soluble solid content of less than 7000 mg/L.
6. Secondary filtration treatment: The heavy oil produced water after the primary filtration treatment was subjected to a secondary filtration treatment, wherein anthracite and carborundum were used as filter materials; the normal filtration rate was 7.8 m/h; the calibration filtration rate was 8.7 m/h; and the working period was 24 hours. The backwashing was a gas-water combined backwashing, wherein the water washing intensity was 13 L/s·m², and the water washing time was 10 min; the gas washing intensity was 16 NL/s·m², and the gas washing time was 5 min.

The heavy oil produced water after the secondary filtration treatment had an oil content of less than 2 mg/L, a suspended matter content of less than 2 mg/L, a silica content of less than 300 mg/L, a total hardness of less than 200 mg/L and a total soluble solid content of less than 7000 mg/L.

The above primary filtration treatment and secondary filtration treatment may be carried out in the primary filter 1-5 and the secondary filter 1-6, respectively.

III. Advanced Treatment of Removing Divalent and Trivalent Scaling Ions
7. Primary advanced treatment: The heavy oil produced water after the secondary filtration treatment was subjected to a primary advanced treatment by using the macroporous weak acid resin prepared in Example 1. The loading height of the macroporous weak acid resin was 1.4 m, and the working filtration rate was 20 m/h.

The heavy oil produced water after the primary advanced treatment had a total hardness controlled at 5 mg/L or less, an oil content of less than 2 mg/L, a suspended matter content of less than 2 mg/L, a silica content of less than 300 mg/L, and a total soluble solid content of less than 7000 mg/L.
8. Secondary advanced treatment: The heavy oil produced water after the primary advanced treatment was subjected to a secondary advanced treatment by using the macroporous weak acid resin prepared in Example 1. The loading height of the macroporous weak acid resin was 1 m, and the working filtration rate was 30 m/h.

The heavy oil produced water after the secondary advanced treatment had a total content of divalent and trivalent scaling ions controlled at 50 μg/L or less, an oil content of less than 2 mg/L, a suspended matter content of less than 2 mg/L, a silica content of less than 300 mg/L, and a total soluble solid content of less than 7000 mg/L.

The above primary advanced treatment and secondary advanced treatment may be carried out in the primary advanced treatment device 1-7 and the secondary advanced treatment device 1-8, respectively.

The produced water from the secondary advanced treatment was the heavy oil produced water to be recycled for use in the steam injection boiler. Generally, the produced water was collected in the external water deliver tank 1-9 before being delivered to the steam injection boiler.

### IV. Regeneration Treatment

In the above method, when the total hardness of the heavy oil produced water after the primary advanced treatment is more than 5 mg/L, or when the concentration of divalent and trivalent scaling ions in the heavy oil produced water after the secondary advanced treatment is more than 50 μg/L, it indicates that the macroporous weak acid resin in the primary advanced treatment device or the secondary advanced treatment device has been inactivated (i.e., poisoned or saturated). In this case, the above method further includes in situ regenerating the inactivated macroporous weak acid resin, and the regeneration process includes the following processes.

The macroporous weak acid resin was backwashed with water after the advanced treatment (water with a concentration of divalent and trivalent scaling ions of 50 μg/L or less), and then soaked in a hydrochloric acid solution with a mass concentration of 5% until the height of the resin was reduced by 30% (generally requiring at least 1 hour). Subsequently, the macroporous weak acid resin was soaked in a sodium hydroxide solution with a mass concentration of 5% until the height of the resin was increased by 65% (generally requiring at least 1.5 hours), and the macroporous weak acid resin was again washed with water the advanced treatment (i.e., soft water). Thereafter, untreated heavy oil produced water was injected into the macroporous weak acid resin to test the treatment effect of the macroporous weak acid resin on the heavy oil produced water. When the concentration of divalent and trivalent scaling ions in the treated heavy oil produced water was 50 μg/L or less, the resin regeneration was completed. When the concentration of divalent and trivalent scaling ions in the treated water was more than 50 μg/L, the above regeneration process was repeated until the concentration of divalent and trivalent scaling ions in the heavy oil produced water after the advanced treatment was 50 μg/L or less.

The recovery of the adsorption capacity of the regenerated macroporous weak acid resin for organic matters was observed. The regenerated macroporous weak acid resin (regenerated after the inactivation of the loaded macroporous weak acid resin in Example 1) was used for the treatment of heavy oil extraction water. The COD in the water was reduced from 350 mg/L to 300 mg/L, with a reduction in COD the same as that of a newly prepared macroporous weak acid resin, suggesting that the adsorption capacity of the regenerated macroporous weak acid resin for organic matters can be substantially restored to the level of a newly prepared macroporous weak acid resin. The above results indicate there is a weak association affinity between the macroporous weak acid resin and the organic matters it adsorbs. The regeneration process allows the macroporous weak acid resin to shrink and expand, which facilitates the desorption of organic matters in the resin, thereby essentially restoring the ability of the macroporous weak acid resin in adsorbing organic matters.

In some embodiments, when the macroporous weak acid resin in the primary advanced treatment device or the secondary advanced treatment device has undergone the regeneration treatment, the advanced treatment device that is loaded with the regenerated macroporous weak acid resin may be used as the secondary advanced treatment device, and the advanced treatment device that has not undergone regeneration treatment and has no inactivated macroporous weak acid resin is used as the primary advanced treatment device. This ensures the effectiveness of the advanced treatment of the heavy oil produced water, to keep the concentration of divalent and trivalent scaling ions in the treated heavy oil produced water at 50 μg/L or less.

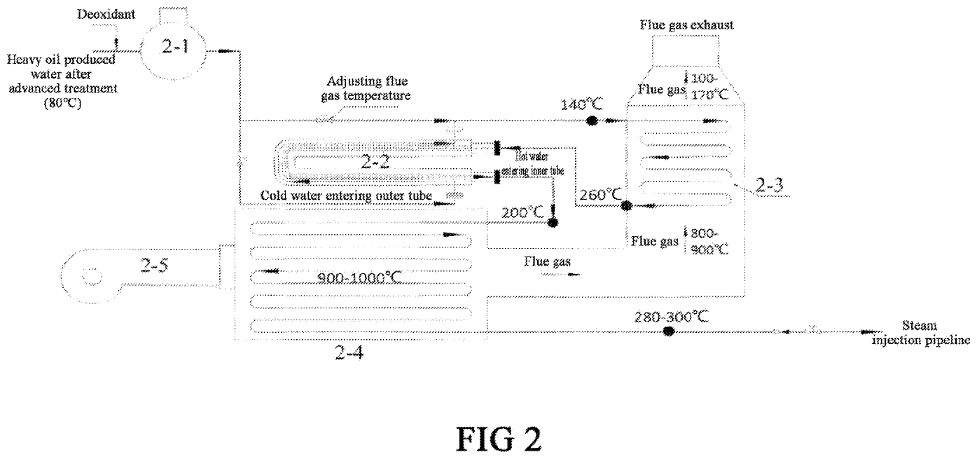

In a specific embodiment, the heavy oil produced water treated by the method for recycling heavy oil produced water for use in a steam injection boiler generally exits from the secondary advanced treatment device into the external water delivery tank 1-9, externally delivered via a pump to the inlet tank of the steam injection boiler, and enters the steam injection boiler by forced pressurization through the plunger pump 2-1. The workflow of the steam injection boiler is shown in FIG. 2. The heavy oil produced water after the advanced treatment firstly enters the outer tube of the heat exchanger 2-2, where it reaches 140° C. through heat exchange with the hot water (260° C.) in the inner tube of the heat exchanger 2-2; and enters the inlet of the convection section 2-3 through the bypass line regulation, where it reaches 260° C. through heat exchange with the flue gas (800-900° C.). Subsequently, it enters the inner tube of the heat exchanger 2-2, where it cools down to 200° C. through heat exchange with the water in the outer tube of the heat exchanger 2-2. Finally, it enters the radiant section 2-4 and is heated by the combustor 2-5 (900-1000° C.) to produce saturated steam with a dryness of 80% and a temperature of 280-300° C. The steam is injected into the oil reservoir through the steam injection pipeline to realize steam oil recovery.

### Comparative Example 1

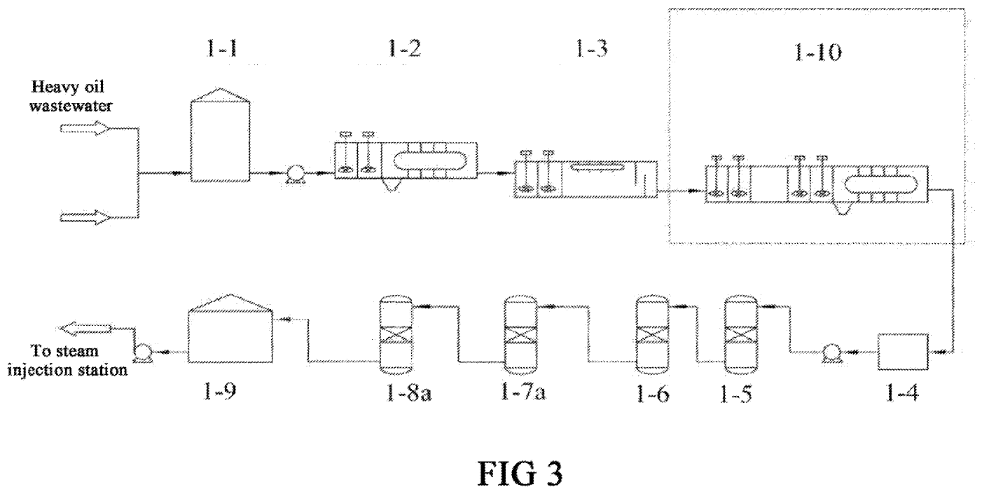

This comparative example provides a method for recycling heavy oil produced water for use in a steam injection boiler including a desilication treatment, which is carried out in the system for recycling heavy oil produced water for use in a steam injection boiler shown in FIG. 3. The system is based on the system provided in Example 1 with the addition of a desilication unit 1-10 and auxiliary facilities (reagent feeding system and silica sludge treatment system). The desilication unit 1-10 was fed with sodium hydroxide, magnesium salts (magnesium chloride and/or magnesium oxide), polyaluminum, polyacrylamide and the like, and a primary softening treatment device 1-7a and a secondary softening treatment device 1-8a were used instead of the primary advanced treatment device 7 and the secondary advanced treatment device 8, respectively. The primary softening treatment device 1-7a and the secondary softening treatment device 1-8a were loaded with a conventional macroporous weak acid resin (Model D113, manufactured by Rohm and Haas), instead of the macroporous weak acid resin prepared in Example 1.

The method provided in this comparative example is substantially the same as the method of Example 2, except that:

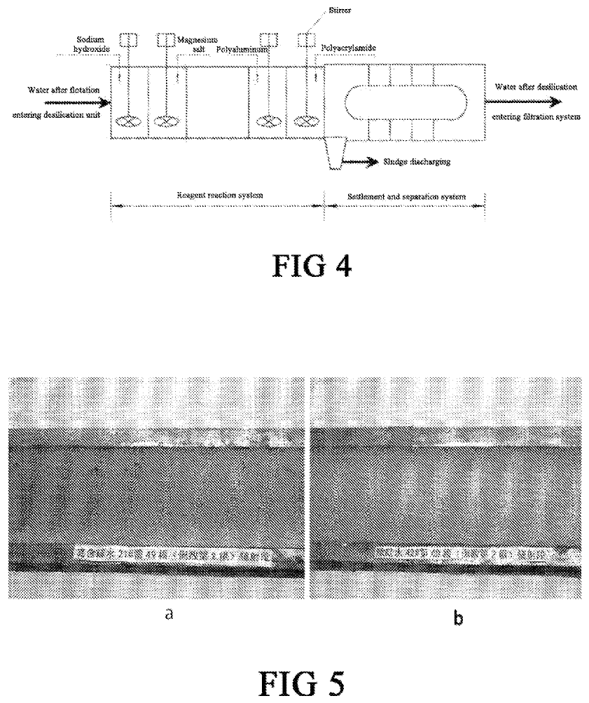

The softening treatment with the conventional macroporous weak acid resin was employed instead of the advanced removal treatment with the macroporous weak acid resin used in Example 2, and the step of desilication treatment was added sequentially between the flotation and impurity removal treatment and the filtration treatment. Specifically, the heavy oil produced water after the flotation and impurity removal treatment was fed into a desilication unit having a pH of 11-13 and containing a magnesium oxide desilication agent (Model HF-1) for treatment. The process of desilication is shown in FIG. 4. The heavy oil produced water after the desilication treatment was then fed into a suction filtration tank, and the subsequent steps of the suction filtration, filtration, and softening treatment were carried out according to the procedure in Example 2.

The above method for recycling heavy oil produced water for use in a steam injection boiler was carried out by using the same heavy oil produced water as in Example 2 as a subject to be treated. The test results of the silica concentration and concentration of divalent and trivalent scaling ions for the raw heavy oil produced water, the final produced water of Example 2 and the final produced water of Comparative Example 1 are summarized in Table 2 (Total in Table 2 means the sum of the concentration of divalent and trivalent scaling ions, but excluding the concentration of silica).

TABLE 2

| | SiO₂ | Ca²⁺ | Mg²⁺ | Fe²⁺ | Fe³⁺ | Al³⁺ | Ba²⁺ | Sr³⁺ | Total |
|---|---|---|---|---|---|---|---|---|---|
| Test Samples | mg/L | μg/L | | | | | | | |
| Raw heavy oil | 298 | 19880 | 5214 | 72 | 31 | 350 | 241 | 520 | 26308 |
| produced water | | | | | | | | | |
| Example 2 | 298 | 3.1 | 4.2 | 5.1 | 2.2 | 1.9 | 4.1 | 2.9 | 23.5 |
| Comparative | 100 | 263.9 | 16.3 | 10.1 | 12.5 | 18.9 | 52.8 | 87.5 | 462 |
| Example 1 | | | | | | | | | |

The produced water of Example 2, which was subjected to desilication, is hereinafter referred to as heavy oil wastewater without desilication; and the produced water of Comparative Example 1 after desilication is hereinafter referred to heavy oil wastewater with desilication. As can be seen from Table 2, the main differences between the two produced water in terms of water quality are: (1) The silica concentrations are different. The heavy oil wastewater without desilication has a silica concentration of 298 mg/L and is a highly silicon-containing wastewater; and the heavy oil wastewater with desilication has a silica concentration of 100 mg/L and is a de-siliconized wastewater, with the silica content of the heavy oil wastewater without desilication nearly 3 times the silica content of the heavy oil wastewater with desilication. (2) The concentrations of divalent and trivalent scaling ions are different. The concentration of divalent and trivalent scaling ions in the heavy oil wastewater without desilication is 23.5 μg/L; and the concentration of divalent and trivalent scaling ions in the heavy oil wastewater with desilication is 462 μg/L and is 20 times the concentration in the heavy oil wastewater without desilication.

### Testing Example 1

In order to verify whether the heavy oil produced water obtained from the treatment of Comparative Example 1 and Example 2 can be reused in a boiler, two steam injection boilers were used to conduct a comparison test between the reuse of the heavy oil wastewater without desilication in a steam injection boiler and the reuse of the heavy oil wastewater with desilication in a steam injection boiler. One boiler was used for the reuse of the heavy oil wastewater without desilication, i.e., the heavy oil produced water after the treatment in Example 2, with a steam capacity of 10 t/h; and the other boiler was used for the reuse of the heavy oil wastewater with desilication, i.e., the heavy oil produced water after the treatment in Comparative Example 1, with a steam capacity of 10 t/h. The test started on May 2, 2010, and the whole test was divided into two stages:
Stage I: May 2, 2010 to Jun. 30, 2010, planned steam injection: 10,000 m³, actual steam injection: 11,374 m³;
Stage II: Jul. 10, 2010 to May 6, 2011, planned steam injection: 50,000 m³, actual steam injection: 57,000 m³.

At the end of the test, the furnace tubes of the boiler for reuse of the highly silicon-containing heavy oil wastewater and the boiler for reuse of the heavy oil wastewater with desilication were cut off. FIG. 5 shows photographs of the furnace tube walls of the two boilers, wherein panel a corresponds to the boiler for reuse of the highly silicon-containing heavy oil wastewater, and panel b corresponds to the boiler for reuse of the heavy oil wastewater with desilication.

As can be seen in FIG. 5, the scaling in the boiler for reuse of highly silicon-containing heavy oil wastewater is comparable to that in the boiler for reuse of heavy oil wastewater with desilication, both at a relatively minor extent. This result suggests that by controlling the divalent and trivalent scaling ions at a trivial concentration, it is possible to obtain heavy oil produced water that does not scale without desilication, and achieve the purpose of reusing heavy oil wastewater without desilication in a boiler, with significant economic, environmental and social benefits.

### Testing Example 2

This testing example provides field test results of the method for recycling heavy oil produced water for use in a steam injection boiler without desilication of Example 2. The method for recycling heavy oil produced water for use in a steam injection boiler without desilication of Example 2 was scaled up and applied on the basis of successes in indoor researches and the on-site pilot test. Upon the application, all the projects with high silica contents (silica contents of less than 300 mg/L) stopped to run the desilication process, and the boilers were running smoothly with remarkable economic benefits.

In application, the method for recycling heavy oil produced water for use in a steam injection boiler without desilication of the present disclosure has the following advantages.
(1) The procedure of the process is shortened. Since the desilication unit and auxiliary facilities (reagent feeding system and silica sludge treatment system) are eliminated, the capital investment can be saved by 15% or more.
(2) The operation cost is significantly reduced. With a possible saving of 4-6 Chinese yuan (CNY) in the cost of desilication chemicals per cubic meter of heavy oil produced water, 100 million CNY or more can be saved annually by utilizing this technology in the Liaohe Oilfield.
(3) The cost for sludge treatment is significantly reduced. Since the desilication system is eliminated and no silica sludge is generated, 1,500 CNY per square meter can be saved for the silica sludge treatment, and 100 million CNY for sludge treatment can be saved annually by utilizing this technology in the Liaohe Oilfield.
(4) By avoiding scaling in the filtration and softening systems, the production efficiency is significantly increased, and the costs of production and maintenance are significantly reduced.

1. A method for recycling heavy oil produced water for use in a steam injection boiler without desilication, comprising subjecting the heavy oil produced water sequentially to a pre-treatment, a filtration treatment, and an advanced treatment of removing divalent and trivalent scaling ions, wherein the resin used in the advanced treatment of removing divalent and trivalent scaling ions comprises a macroporous weak acid resin, and
wherein the raw materials for the macroporous weak acid resin include a matrix material, a porogenic agent, a reinforcing agent, an initiator, and a dispersant in a mass ratio of (25-35):(32-50):(1-3):(0.8-1.2):(6-9).

2. The method for recycling heavy oil produced water for use in a steam injection boiler without desilication according to claim 1, wherein the method comprises no desilication treatment.

3. The method for recycling heavy oil produced water for use in a steam injection boiler without desilication according to claim 1, wherein the heavy oil produced water after the advanced treatment of removing divalent and trivalent scaling ions has an oil content of less than 2 mg/L, a suspended matter content of less than 2 mg/L, a silica content of less than 300 mg/L, a total soluble solid content of less than 7000 mg/L, and a concentration of divalent and trivalent scaling ions of 50 μg/L or less.

4. The method for recycling heavy oil produced water for use in a steam injection boiler without desilication according to claim 3, wherein the advanced treatment of removing divalent and trivalent scaling ions comprises a primary advanced treatment and a secondary advanced treatment in sequence, wherein the hardness of the heavy oil produced water after the primary advanced treatment is less than 5 mg/L, and the concentration of divalent and trivalent scaling ions in the heavy oil produced water after the secondary advanced treatment is 50 μg/L or less.

5. The method for recycling heavy oil produced water for use in a steam injection boiler without desilication according to claim 4, wherein when the hardness of the heavy oil produced water after the primary advanced treatment is greater than 5 mg/L, or when the concentration of divalent and trivalent scaling ions of the heavy oil produced water after the secondary advanced treatment is greater than 50 μg/L, the method further comprises a process of regenerating the macroporous weak acid resin used in the primary advanced treatment or the secondary advanced treatment, which comprises: soaking the macroporous weak acid resin in an acid solution and an alkaline solution in sequence, until the concentration of divalent and trivalent scaling ions of the heavy oil produced water treated with the regenerated macroporous weak acid resin reaches 50 μg/L or less.

6. The method for recycling heavy oil produced water for use in a steam injection boiler without desilication according to claim 5, wherein the duration of soaking the macroporous weak acid resin in the acid solution is ≥1 hour, and the duration of soaking the macroporous weak acid resin in the alkaline solution is ≥1.5 hour;
wherein the acid solution has a pH≤2, and the alkaline solution has a pH≥13;
wherein the acid solution comprises hydrochloric acid with a mass concentration of 3-5%; and the alkaline solution comprises a sodium hydroxide solution with a mass concentration of 3-5%.

7. The method for recycling heavy oil produced water for use in a steam injection boiler without desilication according to claim 5, wherein the regeneration process further includes a process of washing with softened water before soaking in the acid solution and/or after the soaking in the alkaline solution.

8. The method for recycling heavy oil produced water for use in a steam injection boiler without desilication according to claim 1, wherein the pre-treatment comprises an oil-removal buffer treatment, an inclined plate oil-removal treatment, and a flotation treatment performed in sequence;
wherein the oil-removal buffer treatment is performed at a treat temperature of 60-90° C. for a duration of 12 hours; and
wherein the inclined plate oil-removal treatment comprises the processes of rapid mixing, slow reaction, and inclined plate precipitation.

9. The method for recycling heavy oil produced water for use in a steam injection boiler without desilication according to claim 8, wherein the heavy oil produced water after the oil-removal buffer treatment has an oil content of less than 500 mg/L and a suspended matter content of less than 300 mg/L; the heavy oil produced water after the inclined plate oil-removal treatment has an oil content of less than 50 mg/L and a suspended matter content of less than 100 mg/L; and the heavy oil produced water after the flotation treatment has an oil content of less than 10 mg/L, a suspended matter content of less than 20 mg/L, a silica content of less than 300 mg/L, and a total hardness of less than 200 mg/L.

10. The method for recycling heavy oil produced water for use in a steam injection boiler without desilication according to claim 1 wherein the heavy oil produced water after the filtration treatment has a total hardness of less than 200 mg/L, an oil content of less than 2 mg/L, a suspended matter content of less than 2 mg/L, a silica content of less than 300 mg/L, and a total soluble solid content of less than 7000 mg/L;

11. The method for recycling heavy oil produced water for use in a steam injection boiler without desilication according to claim 10, wherein the filtration treatment comprises a primary filtration treatment and a secondary filtration treatment in sequence; the heavy oil produced water after the primary filtration treatment has a total hardness of less than 200 mg/L, an oil content of less than 5 mg/L, a suspended matter content of less than 5 mg/L, a silica content of less than 300 mg/L, and a total soluble solid content of less than 7000 mg/L; and the heavy oil produced water after the secondary filtration treatment has a total hardness of less than 200 mg/L, an oil content of less than 2 mg/L, a suspended matter content of less than 2 mg/L, a silica content of less than 300 mg/L, and a total soluble solid content of less than 7000 mg/L;
wherein the filtration treatment further comprises a suction filtration treatment prior to the primary filtration treatment.

12. The method for recycling heavy oil produced water for use in a steam injection boiler without desilication according to claim 1, wherein in the macroporous weak acid resin, the mass ratio of the porogenic agent to the reinforcing agent is 40:2.

13. The method for recycling heavy oil produced water for use in a steam injection boiler without desilication according to claim 1, wherein the mass ratio of the matrix material, the porogenic agent, the reinforcing agent, the initiator and the dispersant is 30:(40-50):(1-2):1:(7-8).

14. The method for recycling heavy oil produced water for use in a steam injection boiler without desilication according to claim 1, wherein the reinforcing agent comprises acrylonitrile and/or isobutyronitrile;
the porogenic agent comprises one or a combination of two or more of toluene, xylene, polyethylene glycol and hydroxypropyl cellulose;
the matrix material comprises an acrylate-based compound;
the dispersant comprises one or a combination of two or more of polyvinyl alcohol, gelatin, and carboxymethyl cellulose.

15. The method for recycling heavy oil produced water for use in a steam injection boiler without desilication according to claim 1, wherein in the macroporous weak acid resin, the raw materials for the macroporous weak acid resin further includes a crosslinking agent; and the crosslinking agent comprises divinylbenzene;
wherein the mass ratio of the matrix material to the crosslinking agent is (25-35):(15-25).

16. The method for recycling heavy oil produced water for use in a steam injection boiler without desilication according to claim 1, wherein the macroporous weak acid resin has a pore size of 800-900 nm; the macroporous weak acid resin is capable of withstanding a high temperature of 95° C. or more; the macroporous weak acid resin has an exchange capacity of 3.9-4.1 mmol/ml; the macroporous weak acid resin has a pore area of 800-1200 m²/g; and the macroporous weak acid resin has a mechanical strength of 290-310 N/mm².

17. The method for recycling heavy oil produced water for use in a steam injection boiler without desilication according to claim 1, wherein the macroporous weak acid resin is prepared by a process comprising: mixing the raw materials for the macroporous weak acid resin and then carrying out a suspension polymerization to obtain resin beads; and subjecting the resin beads to hydrolysis to obtain the macroporous weak acid resin;
wherein during the suspension polymerization, the reaction temperature is 70-95° C., the reaction time is 7-10 hours, and the reaction pressure is ambient pressure; during the hydrolysis, the hydrolysis temperature is 100° C., and the hydrolysis time is 1 hour.

18. A system for recycling heavy oil produced water for use in a steam injection boiler without desilication, which comprises a pre-treatment system, a filtration system, and an advanced treatment system connected in sequence, wherein the advanced treatment system is loaded with a macroporous weak acid resin for removing divalent and trivalent scaling ions from the heavy oil produced water.

19. The system for recycling heavy oil produced water for use in a steam injection boiler without desilication according to claim 18, wherein the pre-treatment system comprises an oil-removal buffer tank, an inclined plate oil-removal tank, and a DAF flotation machine in communication in sequence; the filtration system comprises a primary filter and a secondary filter in communication in sequence; the advanced treatment system comprises a primary advanced treatment device and a secondary advanced treatment device in communication in sequence; the DAF flotation machine is in communication with the primary filter, and the secondary filter is in communication with the primary advanced treatment device;
wherein a suction filtration tank is connected between the DAF flotation machine and the primary filter.

20. The system for recycling heavy oil produced water for use in a steam injection boiler without desilication according to claim 18, wherein the system for recycling heavy oil produced water for use in a steam injection boiler is capable of implementing the method for recycling heavy oil produced water for use in a steam injection boiler without desilication according to claim 1.
